(19) United States
(12) Patent Application Publication
(10) Pub. No.: US 2023/0143913 A1
(43) Pub. Date: May 11, 2023

(54) HERMETIC TARPAULIN DEVICE AND NURSING ROOM

(71) Applicant: Shenzhen Relicare Medical Co., Ltd., Shenzhen (CN)

(72) Inventors: Wei HE, Shenzhen (CN); Huiling LI, Shenzhen (CN); Yutai HUANG, Shenzhen (CN); Lifei ZENG, Shenzhen (CN); Guoyuan ZHU, Shenzhen (CN); Tao RAO, Shenzhen (CN)

(73) Assignee: Shenzhen Relicare Medical Co., Ltd., Shenzhen (CN)

(21) Appl. No.: 18/147,893

(22) Filed: Dec. 29, 2022

Related U.S. Application Data
(63) Continuation of application No. PCT/CN2020/102994, filed on Jul. 20, 2020.

(30) Foreign Application Priority Data
Jun. 30, 2020 (CN) 202010614434.6

(51) Int. Cl. A61G 10/00

(52) U.S. Cl. CPC A61G 10/005

(57) ABSTRACT

Disclosed are a hermetic tarpaulin device and a nursing room. The hermetic tarpaulin device includes a frame and a tarpaulin body. The frame can be unfolded or folded into a predetermined shape. The tarpaulin body can be connected to the frame. When the frame is unfolded, the tarpaulin body is unfolded to form a hermetic space completely isolated from an outside world, and when the frame is folded, the tarpaulin body is folded into a whole. The tarpaulin body can be unfolded with the frame to form a hermetic space completely isolated from the outside world, which can achieve complete isolation from the outside world, thereby improving the isolation effect, and the nursing room can be more convenient to build, and can also reduce the cost and reduce the occupied space.

### CROSS-REFERENCE TO RELATED APPLICATIONS

This application is a continuation application of International Application No. PCT/CN2020/102994, filed on Jul. 20, 2020, which claims priority to Chinese Patent Application No. 202010614434.6, filed on Jun. 30, 2020. The disclosures of the above-mentioned applications are incorporated herein by reference in their entireties.

### TECHNICAL FIELD

The present disclosure relates to the technical field of medical equipment, in particular to a hermetic tarpaulin device and a nursing room.

### BACKGROUND

When patients with infectious diseases are treated, such patients need to be isolated to prevent the spread of the infectious virus to the outside world. Nowadays, patients with infectious diseases are generally transferred to wards formed by engineering construction methods such as hospitals. However, this kind of ward cannot be moved, and it takes a certain amount of time to transfer patients to the ward, which may delay the best time for treatment. Meanwhile, the cost of this kind of ward is high. In addition, when clustered infectious diseases occur, it is difficult for the ward to meet the use demand.

In the related art, there are some devices that can be temporarily constructed to form an isolation space to replace the above-mentioned wards. These devices generally consist of frames and canvas. When building, the frame is first unfolded into a structure that occupies a certain space, and then multiple pieces of canvas are connected to the unfolded frame, and the canvas and the frame together form a simple temporary ward. This kind of temporary ward has great defects in use. A lot of gaps exist between the connecting parts, especially when there is a severe infectious disease transmitted by aerosol, it is very easy for the infectious virus to spread to the outside world, so the isolation effect of the ward formed by the engineering construction method cannot be achieved.

### SUMMARY

The present disclosure provides a hermetic tarpaulin device and a nursing room, which aims to solve the problem of simple structures of existing related devices.

According to a first aspect, an embodiment of the present disclosure provides a hermetic tarpaulin device, including:

a frame being unfolded or folded into a predetermined shape; and

a tarpaulin body connected to the frame, when the frame is unfolded, the tarpaulin body is unfolded to form a hermetic space completely isolated from an outside world, and when the frame is folded, the tarpaulin body is folded into a whole.

In some embodiments of the hermetic tarpaulin device, the frame includes a plurality of support rods.

In some embodiments of the hermetic tarpaulin device, the frame includes a first support upright, a second support upright, a first support cross rod and a second support cross rod, the first support upright and the second support upright are vertical and parallel to each other, the first support cross rod and the second support cross rod are horizontal and parallel to each other, the first support cross rod is connected to the first support upright, and the second support cross rod is connected to the second support upright.

In some embodiments of the hermetic tarpaulin device, a first diagonal rod is provided between the first support upright and the first support cross rod, and/or a second diagonal rod is provided between the second support upright and the second support cross rod.

In some embodiments of the hermetic tarpaulin device, a third support cross rod is provided between the first support cross rod and the second support cross rod.

In some embodiments of the hermetic tarpaulin device, the first support upright, the second support upright, the first support cross rod, the second support cross rod and the third support cross rod are telescopic rods or folding rods.

In some embodiments of the hermetic tarpaulin device, the frame includes a first support upright, a second support upright, a third support upright and a fourth support upright, the first support upright, the second support upright, the third support upright and the fourth support upright are vertical and parallel to each other, and a fourth support cross rod is provided between the first support upright and the second support upright.

In some embodiments of the hermetic tarpaulin device, a first telescopic connecting frame is provided between the second support upright and the third support upright, a second telescopic connecting frame is provided between the third support upright and the fourth support upright, and a third telescopic connecting frame is provided between the fourth support upright and the first support upright.

In some embodiments of the hermetic tarpaulin device, the tarpaulin body is unfolded to form a hexahedron structure with six surfaces, an interior of the hexahedron structure forms the hermetic space, and at least one surface is designed to have an open state communicating with the outside world and a closed state isolated from the outside world.

In some embodiments of the hermetic tarpaulin device, at least one surface includes at least one curtain movable to open or close the hermetic space.

In some embodiments of the hermetic tarpaulin device, the hermetic tarpaulin device further includes a driving mechanism for driving the curtain to move.

In some embodiments of the hermetic tarpaulin device, the driving mechanism is installed on the frame, the curtain includes a first curtain and a second curtain, the first curtain and the second curtain move away from and approach each other to open or close the hermetic space, the driving mechanism includes a first driving frame and a second driving frame hinged to the frame, the first driving frame is hinged to the second driving frame, a first curtain slider and a first slider driving assembly are provided on the first driving frame, a second curtain slider and a second slider driving assembly are provided on the second driving frame, the first slider driving assembly is configured to drive the first curtain slider to move along the first driving frame, the first curtain slider is fixedly connected to the first curtain, the second slider driving assembly is configured to drive the second curtain slider to move along the second driving frame, and the second curtain slider is fixedly connected to the second curtain.

In some embodiments of the hermetic tarpaulin device, the first slider driving assembly includes a first driving motor and a first conveyor belt assembly, the first curtain slider is fixedly connected to the first conveyor belt assembly, the second slider driving assembly includes a second driving motor and a second conveyor belt assembly, and the second curtain slider is fixedly connected to the second conveyor belt assembly.

In some embodiments of the hermetic tarpaulin device, the driving mechanism further includes a first fixing member and a second fixing member, the first fixing member and the second fixing member are fixedly installed on the frame, the first fixing member is opposite to the second fixing member, the first driving frame is hinged to the first fixing member, and the second driving frame is hinged to the second fixing member.

In some embodiments of the hermetic tarpaulin device, a damping hinge is connected between the first fixing member and the first driving frame, between the first driving frame and the second driving frame, and between the second driving frame and the second fixing member.

In some embodiments of the hermetic tarpaulin device, a magnetic attractor is provided between the first curtain and the second curtain, between the first curtain and other surfaces, and between the second curtain and other surfaces.

In some embodiments of the hermetic tarpaulin device, the curtain includes a first curtain and a second curtain, the first curtain and the second curtain move away from and approach each other to open or close the hermetical space, a first zipper is provided between a top of the first curtain and a surface adjacent to the top of the first curtain, a second zipper is provided between a top of the second curtain and a surface adjacent to the top of the second curtain, the driving mechanism includes a first driving frame and a second driving frame hinged to the frame, the first driving frame is hinged to the second driving frame, a first curtain slider, a first slider driving assembly, a first zipper closure and a first zipper driving assembly are provided on the first driving frame, a second curtain slider, a second slider driving assembly, a second zipper closure and a second zipper driving assembly are provided on the second driving frame, the first slider driving assembly is configured to drive the first curtain slider to move along the first driving frame, the first zipper driving assembly is configured to drive the first zipper closure to move along the first driving frame, the first curtain slider is fixedly connected to the first curtain, the first zipper closure is fixedly connected to a zipper pull of the first zipper, the second slider driving assembly is configured to drive the second curtain slider to move along the second driving frame, the second zipper driving assembly is configured to drive the second zipper closure to move along the second driving frame, the second curtain slider is fixedly connected to the second curtain, and the second zipper closure is fixedly connected to a zipper head of the second zipper.

In some embodiments of the hermetic tarpaulin device, the driving mechanism includes an electric zipper provided between the curtain and other surfaces.

According to a second aspect, an embodiment provides a nursing room, including:

a first support structure that is movable;

a second support structure that is movable, the second support structure and the first support structure being able to approach or move away from each other; and

the hermetic tarpaulin device according to a first aspect of the present disclosure, a frame of the hermetic tarpaulin device is installed on the first support structure and the second support structure.

In some embodiments of the nursing room, the hermetic tarpaulin device is the hermetic tarpaulin device of claim 3, the first support upright and the second support upright in the hermetic tarpaulin device are respectively installed on the first support structure and the second support structure, and a top of the tarpaulin body in the hermetic tarpaulin device is provided with a cloth cover configured to be sleeved on the first support upright and the second support upright.

In some embodiments of the nursing room, an adhesive structure is provided between the tarpaulin body and the first support structure and between the tarpaulin body and the second support structure.

According to a third aspect, an embodiment provides a nursing room, including:

a first support structure that is movable;

a second support structure that is movable;

a third support structure that is movable;

a fourth support structure that is movable, the fourth support structure, the third support structure, the second support structure and the first support structure being able to approach or move away from each other; and

the hermetic tarpaulin device according to a first aspect of the present disclosure, a frame of the hermetic tarpaulin device is installed on the first support structure, the second support structure, the third support structure and the fourth support structure.

In some embodiments of the nursing room, the hermetic tarpaulin device is the hermetic tarpaulin device as described above, the first support upright, the second support upright, the third support upright and the fourth support upright in the hermetic tarpaulin device are respectively installed on the first support structure, the second support structure, the third support structure and the fourth support structure, and a top of the tarpaulin body in the hermetic tarpaulin device is provided with a cloth cover configured to be sleeved on the first support upright, the second support upright, the third upright and the fourth upright.

In some embodiments of the nursing room, an adhesive structure is provided between the tarpaulin body and the first support structure, between the tarpaulin body and the second support structure, between the tarpaulin body and the third support structure, and between the tarpaulin body and the fourth support structure.

### Beneficial Effects

Implementing the embodiments of the present disclosure will have the following beneficial effects:

According to the above embodiments, since the tarpaulin body of the hermetic tarpaulin device can form a hermetic space that is completely isolated from the outside world with the unfolding of the frame, it can achieve complete isolation from the outside world, thereby improving the isolation effect.

The nursing room according to the above embodiments can be moved. Therefore, when building the nursing room, it can be realized only by controlling the movement of the support structure, which is convenient to build. Compared with the ward formed by engineering construction, it can significantly reduce the cost and reduce the occupied space, and can achieve complete isolation from the outside world, thereby improving the isolation effect.

### BRIEF DESCRIPTION OF THE DRAWINGS

In order to more clearly illustrate the technical solutions in the embodiments of the present disclosure or the prior art, the following will briefly introduce the drawings that need to be used in the description of the embodiments or the prior art. Apparently, the drawings in the following description are only some embodiments of the present disclosure, and those skilled in the art can obtain other drawings according to these drawings without creative efforts.

FIG. 1 shows a schematic structural view of a nursing room according to an embodiment of the present disclosure.

FIG. 2 shows a schematic structural view of the unfolding process of a nursing room according to an embodiment of the present disclosure.

FIG. 3 shows a schematic structural view of a nursing room in an unfolded state according to an embodiment of the present disclosure.

FIG. 4 shows a schematic structural view of a tarpaulin body according to an embodiment of the present disclosure.

FIG. 5 shows a front view of a driving mechanism according to an embodiment of the present disclosure.

FIG. 6 shows a perspective view of a driving mechanism according to an embodiment of the present disclosure.

FIG. 7 shows a schematic structural view of a folding process of a driving mechanism according to an embodiment of the present disclosure.

FIG. 8 shows a schematic structural view of a driving mechanism in a folded state according to an embodiment of the present disclosure.

FIG. 9 shows a partial enlarged view at portion A in FIG. 6.

FIG. 10 shows a schematic structural view of another driving mechanism according to an embodiment of the present disclosure.

FIG. 11 shows a partial enlarged view at portion B in FIG. 10.

FIG. 12 shows a schematic structural view of another nursing room according to an embodiment of the present disclosure.

FIG. 13 shows a schematic structural view of the unfolding process of another nursing room along the direction C according to an embodiment of the present disclosure.

FIG. 14 shows a schematic structural view of the unfolding process of another nursing room along the direction D according to an embodiment of the present disclosure.

FIG. 15 shows a schematic structural view of the unfolding process of the frame of another nursing room according to an embodiment of the present disclosure.

FIG. 16 shows a schematic structural view of another nursing room in the unfolded state according to an embodiment of the present disclosure.

### DETAILED DESCRIPTION OF THE EMBODIMENTS

In order to facilitate the understanding of the present disclosure, the present disclosure will be described more fully below with reference to the relevant drawings. Preferred embodiments of the present disclosure are shown in the accompanying drawings. However, the present disclosure can be implemented in many other different forms and is not limited to the embodiments described herein. On the contrary, the purpose of providing these embodiments is to make the understanding of the contents of the present disclosure more thorough and comprehensive.

It should be noted that when an element is referred to as being “fixed on” another element, it can be directly on the other element or intervening elements may also be present. When an element is referred to as being “connected to” another element, it can be directly connected to the other element or intervening elements may also be present. The terms “vertical”, “horizontal”, “left”, “right”, and similar expressions are used herein for purposes of illustration only.

Unless otherwise defined, all technical and scientific terms used herein have the same meaning as commonly understood by one of ordinary skill in the technical field to which this application belongs. The terms used herein in the specification of the present disclosure are only for the purpose of describing specific embodiments, and are not intended to limit the present disclosure. As used herein, the term “and/or” includes any and all combinations of one or more of the associated listed items.

The embodiments of the present disclosure provide a nursing room. The nursing room can be completely isolated from the outside world, which is suitable for nursing use of severe infectious diseases transmitted through aerosols, influenza-like infectious diseases, tuberculosis infectious diseases, unexplained infectious diseases, and frail and sick people.

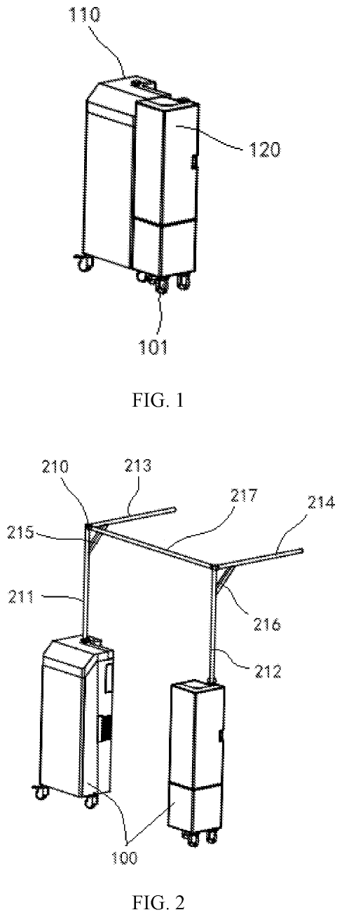

In some embodiments of the present disclosure, as shown in FIG. 1 to FIG. 4, the nursing room includes a movable support structure 100 and a hermetic tarpaulin device 200. The movable support structure 100 mainly plays a role of support, function integration and necessary control. Rollers 101 are provided at the bottom thereof. The hermetic tarpaulin device 200 is installed on the support structure 100 to form a nursing room together with the support structure 100.

It can be understood that the specific number of support structures 100 can be determined according to actual needs. For example, in the embodiments below, the nursing room may include two support structures 100, and the nursing room may include four support structures 100. Besides, the nursing room can also have more composition modes, for example, it can include three support structures 100, or more support structures 100.

In some embodiments of the present disclosure, the nursing room is provided with the movable support structure 100. Therefore, when building the nursing room, it can be realized only by controlling the movement of the support structure 100, which is convenient to build. Compared with the ward formed by engineering construction, it can significantly reduce the cost and reduce the occupied space, and can achieve complete isolation from the outside world, thereby improving the isolation effect.

In an embodiment, as shown in FIG. 1 to FIG. 4, the nursing room includes a first support structure 110, a second support structure 120 and a hermetic tarpaulin device 200, and the hermetic tarpaulin device 200 is installed on the first support structure 110 and the second support structure 120.

In this embodiment, the first support structure 110 and the second support structure 120 can approach or move away from each other, so as to release enough space between them to provide conditions for the hermetic tarpaulin device 200 to unfold.

It should be noted that the movement of the first support structure 110 and the second support structure 120 can be done manually, or by automatic control. When the latter is used, related control devices can be integrated and installed on the first support structure 110 and/or the second support structure 120.

In this embodiment, the hermetic tarpaulin device 200 includes a frame 210 and a tarpaulin body 220. The frame 210 can be unfolded or folded into a predetermined shape. The tarpaulin body 220 can be connected to the frame 210. When the frame 210 is unfolded, the tarpaulin body 220 can be unfolded to form a hermetic space completely isolated from an outside world, and when the frame 210 is folded, the tarpaulin body 220 can be folded into a whole.

It should be noted herein that the tarpaulin body 220 follows the frame 210 and performs related actions, and the corresponding actions of the frame 210 can be realized manually, for example, directly apply force to the frame 210 manually, or indirectly apply force to the frame 210 manually. For example, the frame 210 can be installed on the support structure 100 (the embodiments herein are mainly presented in this way), and the support structure 100 can be manually pushed to move, so as to realize the corresponding action of the frame 210. The corresponding action of the frame 210 can also be realized through automatic control, which can directly control the action of the frame 210 or indirectly control the action of the frame 210 through the support structure 100.

In some embodiments, the frame 210 includes a plurality of support rods. The support rods are installed on the first support structure 110 and the second support structure 120. By driving the first support structure 110 and the second support structure 120 to move, indirectly causing the support rods to perform corresponding actions, the arrangement of the frame 210 can be varied, which is not limited herein.

For ease of understanding, in some embodiments, as shown in FIG. 2, the frame 210 includes a first support upright 211, a second support upright 212, a first support cross rod 213 and a second support cross rod 214, the first support upright 211 and the second support upright 212 are vertical and parallel to each other, the first support cross rod 213 and the second support cross rod 214 are horizontal and parallel to each other, the first support cross rod 213 is connected to the first support upright 211, and the second support cross rod 214 is connected to the second support upright 212.

Thus, the arrangement and combination of the first support upright 211, the first support cross rod 213, the second support upright 212 and the second support cross rod 214 can play the role of propping up the tarpaulin body 220, and the structure is simple, and since the hermetic tarpaulin device 200 can form a hermetic space completely isolated from the outside world, the effect of isolation can also be improved.

Further, in some embodiments, a first diagonal rod 215 is provided between the first support upright 211 and the first support cross rod 213, and/or a second diagonal rod 216 is provided between the second support upright 212 and the second support cross rod 214.

Thus, the first diagonal rod 215 and/or the second diagonal rod 216 can enhance the structural strength, making the entire frame 210 more stable and reliable.

Further, in some embodiments, a third support cross rod 217 is provided between the first support cross rod 213 and the second support cross rod 214. The third support cross rod 217 plays the role of connection and reinforcement, making the whole frame 210 more stable in structure.

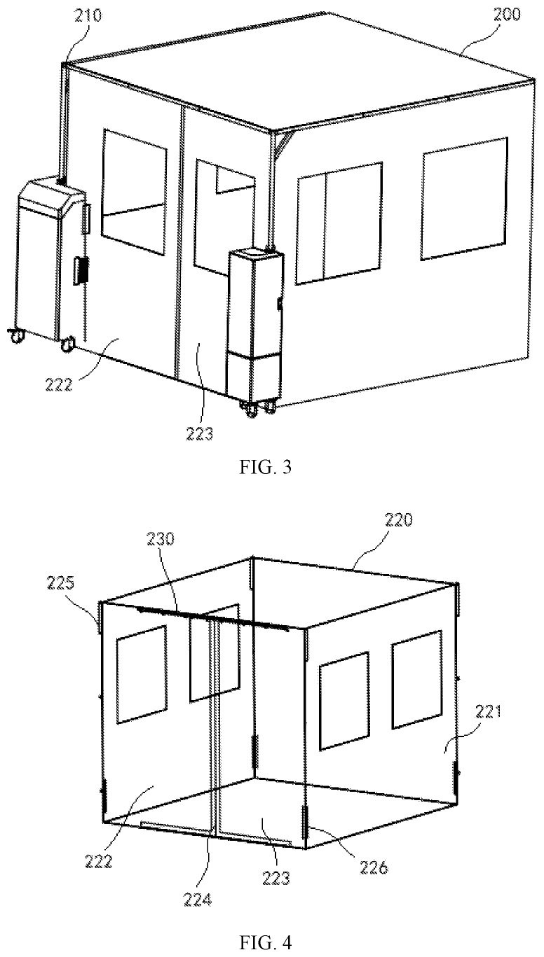

As shown in FIG. 3, the first support upright 211 and the second support upright 212 may be installed on the first support structure 110 and the second support structure 120 respectively. This installation can be carried out after the first support structure 110 and the second support structure 120 are moved into place, and then the tarpaulin body 220 is connected to the frame 210 to form a nursing room.

When the first support upright 211 and the second support upright 212 are installed on the first support structure 110 and the second support structure 120 respectively, a better way is to enable the first support upright 211 and the second support upright 212 to unfold or fold correspondingly following the movement of the first support structure 110 and the second support structure 120. Thus, the first support upright 211 and the second support upright 212 can be installed when the first support structure 110 is close to the second support structure 120.

In some embodiments, the first support upright 211, the second support upright 212, the first support cross rod 213, the second support cross rod 214 and the third support cross rod 217 are telescopic rods or folding rods.

The above process can be understood with reference to FIG. 1 and FIG. 2. First, as shown in FIG. 1, the first support structure 110 is close to the second support structure 120, the first support upright 211, the second support upright 212, the first support cross rod 213, the second support cross rod 214 and the third support cross rod 217 are shrunk into the first support structure 110 and the second support structure 120. Then, as shown in FIG. 2, under the action of external force, the first support structure 110 and the second support structure 120 are far away from each other, correspondingly, the first support upright 211 and the second support upright 212 are extended to a certain length, and the first support cross rod 213, the second support cross rod 214 and the third support cross rod 217 are also extended to a certain length, in this way, the frame 210 is unfolded or folded following the first support structure 110 and the second support structure 120.

In some embodiments, as shown in FIG. 4, the tarpaulin body 220 can be unfolded to form a hexahedron structure with six surfaces, an interior of the hexahedron structure forms a hermetic space, and at least one surface is designed to have an open state that communicates with the outside world and a closed state that is isolated from the outside world.

It should be noted herein that only the hexahedral structure is used as an example to illustrate the tarpaulin body 220, in other embodiments, the tarpaulin body 220 may form a pentahedral structure or other polyhedral structures.

For the tarpaulin body 220, at least one surface thereof includes at least one curtain, and the curtain can be moved to open or close the hermetical space.

It can be understood that the curtain can be separated from other parts of the tarpaulin body 220 (the base 221), and when the two are separated, the hermetical space can be opened.

In some embodiments, the tarpaulin body 220 includes a first curtain 222 and a second curtain 223. The first curtain 222 and the second curtain 223 are connected to the base 221. The first curtain 222 and the second curtain 223 can move away from and approach each other to open or close the hermetic space. The hermetic tarpaulin device 200 also includes a driving mechanism 230. The driving mechanism 230 is installed on the frame 210, for example, can be installed on the aforementioned third support cross rod 217, and it can also replace the third support cross rod 217. The driving mechanism 230 is for driving the first curtain 222 and the second curtain 223 to move.

Therefore, by driving the first curtain 222 and the second curtain 223 to move through the driving mechanism 230, the hermetic space can be quickly opened or closed without human intervention, saving time and effort.

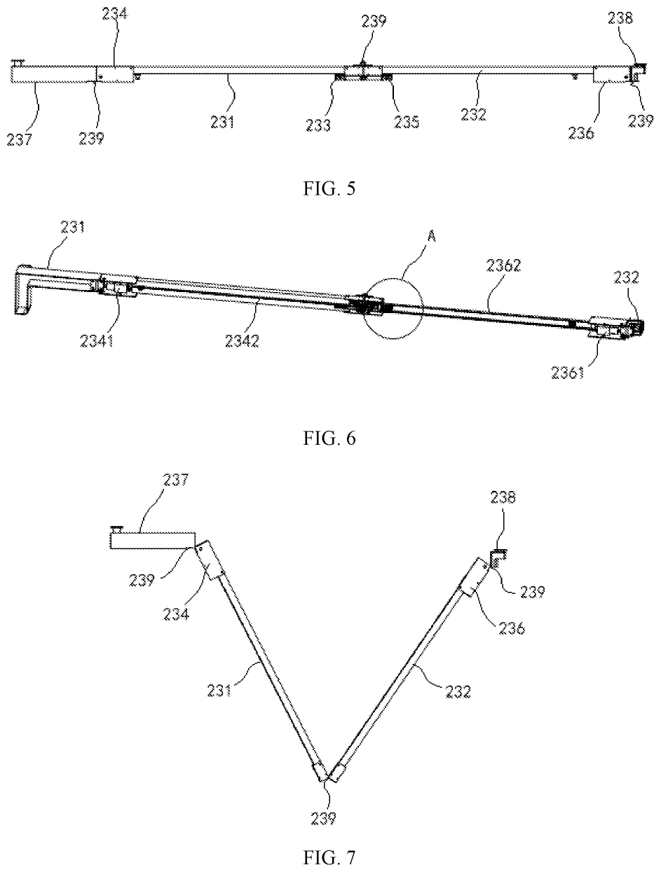

In some embodiments, as shown in FIG. 5 to FIG. 9, the driving mechanism 230 includes a first driving frame 231 and a second driving frame 232 hinged to the frame 210, the first driving frame 231 is hinged to the second driving frame 232, a first curtain slider 233 and a first slider driving assembly 234 are provided on the first driving frame 231, a second curtain slider 235 and a second slider driving assembly 236 are provided on the second driving frame 232, the first slider driving assembly 234 is configured to drive the first curtain slider 233 to move along the first driving frame 231, the first curtain slider 233 is fixedly connected to the first curtain 222, the second slider driving assembly 236 is configured to drive the second curtain slider 235 to move along the second driving frame 232, and the second curtain slider 235 is fixedly connected to the second curtain 223.

In this embodiment, the first curtain slider 233 and the second curtain slider 235 respectively drive the first curtain 222 and the second curtain 223 to move. When the first curtain slider 233 and the second curtain slider 235 move away from each other, the first curtain 222 and the second curtain 223 open the hermetic space. When the first curtain slider 233 and the second curtain slider 235 approach each other, the first curtain 222 and the second curtain 223 enclose the hermetic space.

In some embodiments, the first slider driving assembly 234 includes a first driving motor 2341 and a first conveyor belt assembly 2342, the first curtain slider 233 is fixedly connected to the first conveyor belt assembly 2342, the second slider driving assembly 236 includes a second driving motor 2361 and a second conveyor belt assembly 2362, and the second curtain slider 235 is fixedly connected to the second conveyor belt assembly 2362.

Thus, the first curtain slider 233 and the second curtain slider 235 can be moved by driving the motor to rotate the conveyor belt assembly, thereby realizing the movement of the first curtain 222 and the second curtain 223.

Further, in order to facilitate installation, in some embodiments, the driving mechanism 230 may also include a first fixing member 237 and a second fixing member 238. The first fixing member 237 and the second fixing member 238 are fixedly installed on the frame 210 (for example, installed on the first support upright 211 and the second support upright 212 respectively), and the first fixing member 237 is opposite to the second fixing member 238. The first driving frame 231 is hinged to the first fixing member 237, and the second driving frame 232 is hinged to the second fixing member 238.

The driving mechanism 230 may include a first fixing member 237, a first driving frame 231, a second driving frame 232, a second fixing member 238, or the like. The first fixing member 237 and the second fixing member 238 are fixedly arranged. Between the first driving frame 231 and the first fixing member 237, between the first driving frame 231 and the second driving frame 232, and between the second driving frame 232 and the second fixing member 238 are hinged relationships. Therefore, the driving mechanism 230 has a folding effect, so that it can be folded into the first support structure 110 and the second support structure 120 along with the frame 210.

In some embodiments, a damping hinge 239 is connected between the first fixing member 237 and the first driving frame 231, between the first driving frame 231 and the second driving frame 232, and between the second driving frame 232 and the second fixing member 238. Thus, the above-mentioned folding effect can be better reflected.

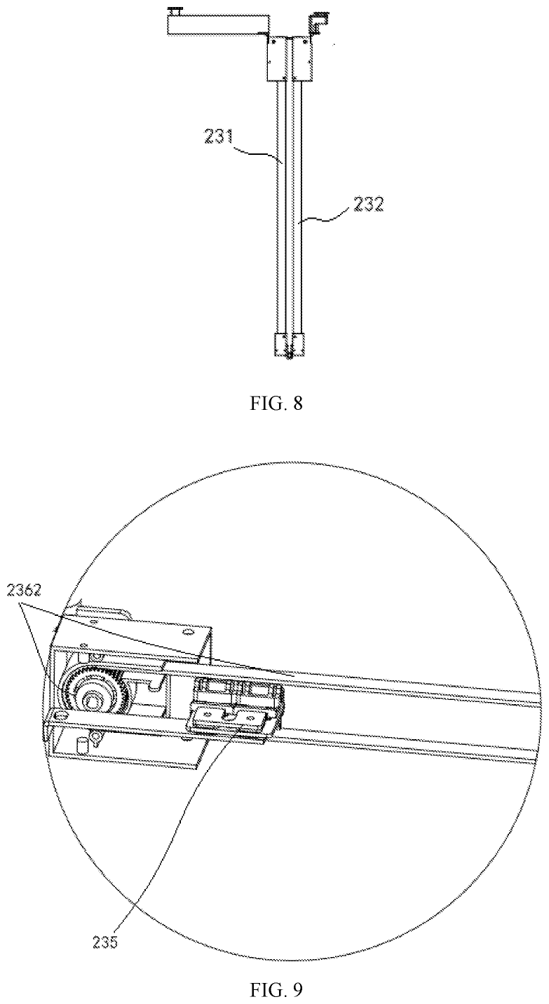

The above process can be understood by referring to FIG. 4 to FIG. 5 and FIG. 7 to FIG. 8. First, as shown in FIG. 4 and FIG. 5, when the tarpaulin body 220 is unfolded into a hexahedron structure, the driving mechanism 230 is a linear structure extending from front to back as a whole, and the driving mechanism 230 can overlap with the aforementioned third support cross rod 217, or the driving mechanism 230 can replace the aforementioned third support cross rod 217, and the first fixing member 237 and the second fixing member 238 can be fixedly connected to the first support upright 211 and the second support upright 212 respectively. Then, as shown in FIG. 7, during the contraction process of the frame 210, the first fixing member 237 and the second fixing member 238 will shrink in the horizontal direction. That is, the first fixing member 237 and the second fixing member 238 will gradually approach in the horizontal direction, and at this time the damping hinge 239 will change a certain angle, thereby driving the first driving frame 231 and the second driving frame 232 to gradually shrink downwards. Finally, as shown in FIG. 8, when the first fixing member 237 and the second fixing member 238 are close together, the first driving frame 231 and the second driving frame 232 will gradually fit together. When the first support upright 211 and the second support upright 212 are retracted into the first support structure body 110 and the second support structure body 120, the first fixing member 237 and the second fixing member 238 will descend in the vertical direction, such that the driving mechanism 230 sinks into the first support structure 110 and the second support structure 120 as a whole, and the state can refer to FIG. 1.

When the above-mentioned driving mechanism 230 is used to move the curtain, the first curtain 222 and the second curtain 223 need to be designed accordingly, for example, it can be carried out in the following manner, cut along the “I” shape at the corresponding position of the base 221. For ease of understanding, as shown in FIG. 4, for example, the above cutting can be performed on one surface of a regular hexahedron. After cutting, for each curtain, such as taking the first curtain 222 as an example, the upper and lower sides of the first curtain 222 will be separated from the base 221, and the side of the first curtain 222 close to the second curtain 223 will be separated from the second curtain. Thus, one end of the first curtain 222 close to the second curtain 223 is fixedly connected to the first curtain slider 233, one end of the second curtain 223 close to the first curtain 222 is fixedly connected to the second curtain slider 235, controlling the first slider driving assembly 234 and the second slider driving assembly 236 can realize the moving away and approaching of the first curtain 222 and the second curtain 223, thereby opening or closing the hermetical space.

It should be pointed out that, the embodiments herein need to always provide a hermetical space completely isolated from the outside world. Therefore, in order to ensure the sealing effect, a magnetic attractor 224 is provided between the first curtain 222 and the second curtain 223, between the first curtain 222 and other surfaces, and between the second curtain 223 and other surfaces. The magnetic attractor 224 can provide suction force, such that when the first curtain 222 and the second curtain 223 approach, the first curtain 222, the second curtain 223 and the base 221 can be closely connected, to eliminate gaps between the first curtain 222, the second curtain 223 and the base 221, and between the first curtain 222 and the second curtain 223.

In some embodiments, the magnetic attractor 224 can be selected according to the material of the tarpaulin body 220. For example, when the tarpaulin body 220 is made of flexible materials such as PE/PVC/TPU, the magnetic attractor 224 can be soft magnets. For another example, when the tarpaulin body 220 is made of a relatively hard material, the magnetic attractor 224 can also be a permanent magnet or the like.

On the other hand, it can be seen from the foregoing description that the frame 210 can be installed on the first support structure 110 and the second support structure 120, the tarpaulin body 220 needs to be connected to the frame 210, so that the tarpaulin body 220 can also be unfolded when the frame 210 is unfolded.

For this, in an embodiment, please refer to FIG. 4, a cloth cover 225 is provided on the tarpaulin body 220. The cloth cover 225 can just cooperate with the first support upright 211 and the second support upright 212, so that the tarpaulin body 220 can be installed on the frame 210. As shown in FIG. 1 to FIG. 3, when the frame 210 shrinks into the first support structure 110 and the second support structure 120, and the first support structure 110 and the second support structure 120 have not been separated, the tarpaulin body 220 can be hung on the frame 210, and then the tarpaulin body 220 can form a hermetic space with the movement of the first support structure 110 and the second support structure 120 and the gradual expansion of the frame 210.

It can be understood that when the tarpaulin body 220 is fully unfolded, taking the hexahedron structure as an example, the interior does not necessarily form a regular shape. For example, as mentioned above, the support structure 100 also has the function of functional integration. Therefore, in some applications, an air intake system and an exhaust system may be provided on the support structure 100 to create a negative pressure environment in the hermetic space. Then, under the influence of the negative pressure, the bottom of the tarpaulin body 220 may be sunken.

For this, in an embodiment, as shown in FIG. 4, an adhesive structure 226 is provided between the tarpaulin body 220 and the first support structure 110 and between the tarpaulin body 220 and the second support structure 120. The adhesive structure 226 can be provided on the bottom of the tarpaulin body 220. Specifically, the adhesive structure 226 can use Velcro to connect the bottom of the tarpaulin body 220 with the corresponding support structure 100 to prevent the aforementioned indentation.

In another embodiment, the driving mechanism 230 includes an electric zipper (not shown) provided between the curtain and other surfaces. The electric zipper, for example, can be installed on the third support cross bar 217. The separation of the first curtain 222, the second curtain 223 and the base 221 is realized through the automatic opening and closing of the electric zipper.

In this embodiment, it should be understood that the magnetic attractor 224 in the foregoing embodiments can also be applied to ensure the sealing effect. For example, the magnetic attractor 224 may be provided between the first curtain 222 and the second curtain 223, between a lower side of the first curtain 222 and the base 221, and between a lower side of the second curtain 223 and the base 221.

In some other embodiments, ordinary zippers can also be provided between the first curtain 222 and the base 221, and between the second curtain 223 and the base 221, and the driving mechanism 230 can be designed as follows.

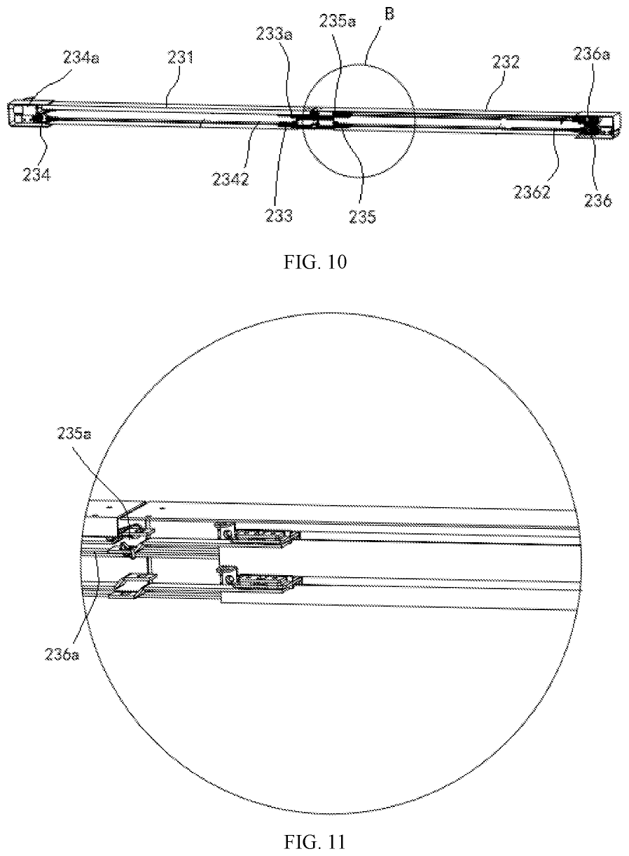

In an embodiment, as shown in FIG. 10 and FIG. 11, the driving mechanism 230 includes a first driving frame 231 and a second driving frame 232 hinged to the frame 210, the first driving frame 231 is hinged to the second driving frame 232, a first curtain slider 233, a first slider driving assembly 234, a first zipper closure 233a and a first zipper driving assembly 234a are provided on the first driving frame 231, a second curtain slider 235, a second slider driving assembly 236, a second zipper closure 235a and a second zipper driving assembly 236a are provided on the second driving frame 232, the first slider driving assembly 234 is configured to drive the first curtain slider 233 to move along the first driving frame 231, the first zipper driving assembly 234a is configured to drive the first zipper closure 233a to move along the first driving frame 231, the first curtain slider 233 is fixedly connected to the first curtain 222, the first zipper closure 233a is fixedly connected to a zipper pull of the first zipper, the second slider driving assembly 236 is configured to drive the second curtain slider 235 to move along the second driving frame 232, the second zipper driving assembly 236a is configured to drive the second zipper closure 235a to move along the second driving frame 232, the second curtain slider 235 is fixedly connected to the second curtain 223, and the second zipper closure 235a is fixedly connected to a zipper head of the second zipper.

It should be noted herein that the first zipper is provided between the upper side of the first curtain 222 and the base 221, the second zipper is provided between the upper side of the second curtain 223 and the base 221. There are two parallel and independent slide rails in the first drive frame 231. The first curtain slider 233 and the first zipper closure 233a respectively move along a slide rail. There are also two parallel and independent slide rails in the second drive frame 232. The second curtain slider 235 and the second zipper closure 235a move along one slide rail, respectively.

In this embodiment, the first curtain slider 233 cooperates with the first zipper closure 233a to drive the first curtain 222 to move, and the second curtain slider 235 cooperates with the second zipper closure 235a to drive the second curtain 223 to move. The movement of the first curtain 222 is taken as an example herein. When the tarpaulin body 220 is in the unfolded state shown in FIG. 3, the first curtain 222 and the second curtain 223 are hermetically connected to each other (mainly relying on the magnetic attractor 224 between them). When the first curtain 222 is driven to move, the first zipper driving assembly 234a is first activated, so that the first zipper closure 233a pulls the zipper pull of the first zipper, thereby separating the first curtain 222 from the base 221. Then, the first slider driving assembly 234 is activated to move the first curtain slider 233, thereby driving the first curtain 222 to move away from the second curtain 223, finally opening the hermetic space. On the contrary, when it is necessary to close the hermetic space, the first slider driving assembly 234 should be activated first, so that the first curtain slider 233 drives the first curtain 222 to move towards the second curtain 222. At this time, the function of the first curtain slider 233 is to sort out the positional relationship between the first curtain 222 and the base 221, so that the two gradually fit together. Afterwards, the first zipper driving assembly 234a is activated again, so that the first zipper closure 233a pulls on the zipper pull of the first zipper, so that the first curtain 222 and the base 221 are sealed again.

In some embodiments, the first zipper driving assembly 234a includes a third driving motor and a third conveyor belt assembly, and the first zipper closure 233a is fixedly connected to the third conveyor belt assembly. The second zipper driving assembly 236a includes a fourth driving motor and a fourth conveyor belt assembly, and the second zipper closure 235a is fixedly connected to the fourth conveyor belt assembly.

For other structural components of the driving mechanism 230 in this embodiment, reference may be made to the foregoing embodiments, which will not be repeated herein. The driving mechanism 230 in this embodiment can be understood as a modified form of the driving mechanism 230 in the preceding embodiments. It is only necessary to add the first zipper driving assembly 234a and the first zipper closure 233a on the first driving frame 231, and add the second zipper driving assembly 236a and the second zipper closure 235a on the second driving frame 232.

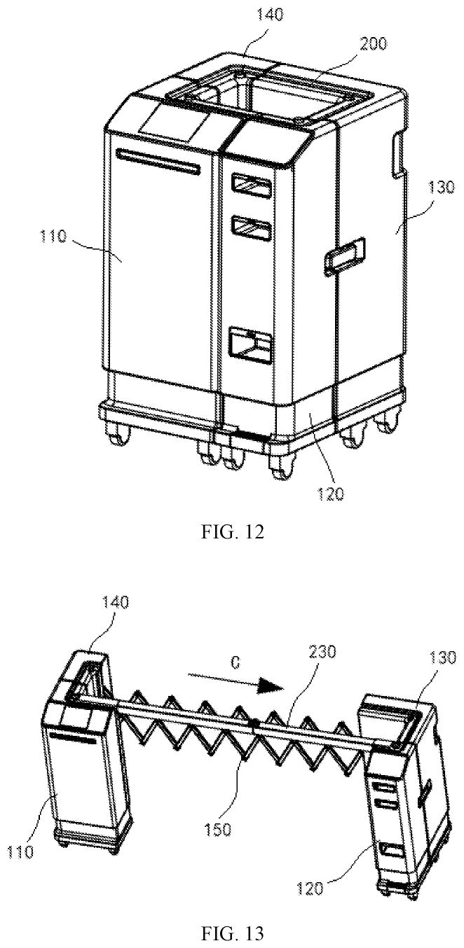

In another embodiment, as shown in FIG. 12 to FIG. 16, the nursing room includes a first support structure 110, a second support structure 120, a third support structure 130, a fourth support structure 140 and a hermetic tarpaulin device 200. The hermetic tarpaulin device 200 is installed on the first support structure 110, the second support structure 120, the third support structure 130 and the fourth support structure 140.

Different from the foregoing embodiments in which the first support structure 110 and the second support structure 120 are used to form the nursing room, in this embodiment, due to the adoption of four support structures 100, the performance of the nursing room in terms of stability will be more superior. More functions can be integrated by setting more support structures 100, for example, the above-mentioned air inlet system and air outlet system can be installed on the corresponding support structures 100, and even lockers and air-conditioning systems can also be installed.

It can be understood that the various frames 210 described above can be applied in the nursing room. For example, same as the previous embodiments, the frame 210 may include a first support upright 211 and a second support upright 212. The first support upright 211 is installed on the first support structure 110, and the second support upright 212 is installed on the second support structure 120.

In nursing rooms employing four support structures 100, the frame 210 can also be deformed.

For example, in some embodiments, as shown in FIG. 15, the frame 210 includes a first support upright 211, a second support upright 212, a third support upright 211a and a fourth support upright 212a. The first support upright 211, the second support upright 212, the third support upright 211a and the fourth support upright 212a are vertical and parallel to each other. A fourth support cross rod 218 is provided between the first support upright 211 and the second support upright 212.

The function of the fourth support cross rod 218 is similar to the function of the third support cross rod 217, and plays the role of reinforcing the overall structural strength of the frame 210.

On the other hand, in the nursing room using four support structures 100, telescopic connecting frames 150 can also be provided between the support structures 100 (the telescopic connecting frame 150 can also be applied in the aforementioned nursing room using two supporting structures 100), such that the movement of the support structure 100 becomes more regulated, and the expansion and contraction of the nursing room will also be differentiated.

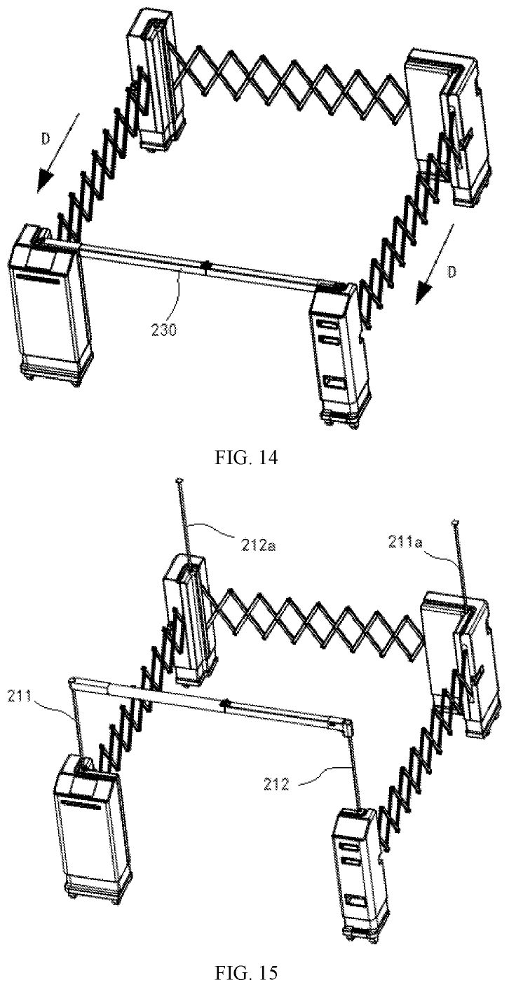

As shown in FIG. 14, a first telescopic connecting frame 151 is provided between the second support upright 212 and the third support upright 211, a second telescopic connecting frame 152 is provided between the third support upright 211a and the fourth support upright 212a, and a third telescopic connecting frame 153 is provided between the fourth support upright 212a and the first support upright 211.

In the embodiment in which the frame 210 is unfolded independently, the telescopic connecting frame 150 may also be directly provided between the support rods.

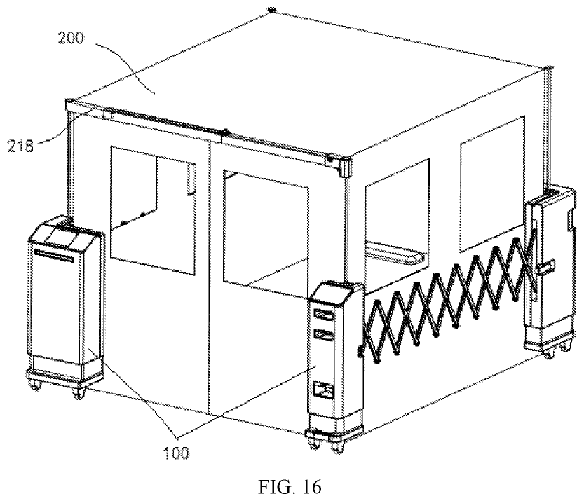

Here, please refer to FIGS. 12-16 in combination, first please refer to FIG. 12, the four support structures 100 are still in the unseparated state, at this time, the tarpaulin body 220 can be installed on the four support structures 120 (through the cloth cover 225, which is described in detail above), then fix the fourth support structure 140 (this fixation can be realized by the rollers 101 provided at the bottom of the fourth support structure 140, and the rollers 101 can be self-locking rollers). Then, as shown in FIG. 13, the second support structure 120 and the third support structure 130 are moved synchronously along the C direction. Next, as shown in FIG. 14, the third support structure 130 and the fourth support structure 140 are fixed, and the first support structure 110 and the second support structure 120 are moved along the D direction, the first support structure 110 is separated from the fourth support structure 140, the second support structure 120 is separated from the third support structure 130. Next, as shown in FIG. 15, the frame 210 is slowly unfolded. During this process, the tarpaulin body 220 will be unfolded along with the frame 210, and finally the nursing room shown in FIG. 16 is formed.

It should be noted that in the aforementioned nursing room using two support structures 100, designs including but not limited to those listed below have been made. The tarpaulin body 220 can adopt a hexahedron structure or other structures. The tarpaulin body 220 can include a first curtain 222 and a second curtain 223. In order to move the first curtain 222 and the second curtain 223, various driving mechanisms 230 are listed. It can be understood that the above designs can all be applied in the nursing room using four support structures 100. For example, the driving mechanism 230 can be designed integrally with the fourth support cross rod 218, or directly replace the fourth support cross rod 218.

The various technical features of the above-mentioned embodiments can be combined arbitrarily, and for the sake of concise description, all possible combinations of the various technical features in the above-mentioned embodiments are not described. However, as long as there is no contradiction in the combination of these technical features, it should be considered as within the scope of the description.

The above-mentioned embodiments only express several implementation modes of the present disclosure, and the description thereof is relatively specific and detailed, but should not be construed as limiting the scope of the present disclosure. It should be noted that those skilled in the art can make several modifications and improvements without departing from the concept of the present disclosure, and these all belong to the scope of the present disclosure. Therefore, the scope of the present disclosure should be based on the appended claims.

What is claimed is:

1. A hermetic tarpaulin device, comprising:
a frame being unfolded or folded into a predetermined shape; and
a tarpaulin body connected to the frame,
wherein when the frame is unfolded, the tarpaulin body is unfolded to form a hermetic space completely isolated from an outside world, and when the frame is folded, the tarpaulin body is folded into a whole.

2. The hermetic tarpaulin device of claim 1, wherein the frame comprises a plurality of support rods.

3. The hermetic tarpaulin device of claim 2, wherein the frame comprises a first support upright, a second support upright, a first support cross rod and a second support cross rod, the first support upright and the second support upright are vertical and parallel to each other, the first support cross rod and the second support cross rod are horizontal and parallel to each other, the first support cross rod is connected to the first support upright, and the second support cross rod is connected to the second support upright.

4. The hermetic tarpaulin device of claim 3, wherein a first diagonal rod is provided between the first support upright and the first support cross rod, and/or a second diagonal rod is provided between the second support upright and the second support cross rod.

5. The hermetic tarpaulin device of claim 4, wherein a third support cross rod is provided between the first support cross rod and the second support cross rod.

6. The hermetic tarpaulin device of claim 5, wherein the first support upright, the second support upright, the first support cross rod, the second support cross rod and the third support cross rod are telescopic rods or folding rods.

7. The hermetic tarpaulin device of claim 2, wherein the frame comprises a first support upright, a second support upright, a third support upright and a fourth support upright, the first support upright, the second support upright, the third support upright and the fourth support upright are vertical and parallel to each other, and a fourth support cross rod is provided between the first support upright and the second support upright.

8. The hermetic tarpaulin device of claim 7, wherein a first telescopic connecting frame is provided between the second support upright and the third support upright, a second telescopic connecting frame is provided between the third support upright and the fourth support upright, and a third telescopic connecting frame is provided between the fourth support upright and the first support upright.

9. The hermetic tarpaulin device of claim 1, wherein the tarpaulin body is unfolded to form a hexahedron structure with six surfaces, an interior of the hexahedron structure forms the hermetic space, and at least one surface is designed to have an open state communicating with the outside world and a closed state isolated from the outside world.

10. The hermetic tarpaulin device of claim 9, wherein at least one surface comprises at least one curtain movable to open or close the hermetic space.

11. The hermetic tarpaulin device of claim 10, further comprising:
a driving mechanism for driving the curtain to move.

12. The hermetic tarpaulin device of claim 11, wherein the driving mechanism is installed on the frame, the curtain comprises a first curtain and a second curtain, the first curtain and the second curtain move away from and approach each other to open or close the hermetic space, the driving mechanism comprises a first driving frame and a second driving frame hinged to the frame, the first driving frame is hinged to the second driving frame, a first curtain slider and a first slider driving assembly are provided on the first driving frame, a second curtain slider and a second slider driving assembly are provided on the second driving frame, the first slider driving assembly is configured to drive the first curtain slider to move along the first driving frame, the first curtain slider is fixedly connected to the first curtain, the second slider driving assembly is configured to drive the second curtain slider to move along the second driving frame, and the second curtain slider is fixedly connected to the second curtain.

13. The hermetic tarpaulin device of claim 12, wherein the first slider driving assembly comprises a first driving motor and a first conveyor belt assembly, the first curtain slider is fixedly connected to the first conveyor belt assembly, the second slider driving assembly comprises a second driving motor and a second conveyor belt assembly, and the second curtain slider is fixedly connected to the second conveyor belt assembly.

14. The hermetic tarpaulin device of claim 12, wherein the driving mechanism further comprises a first fixing member and a second fixing member, the first fixing member and the second fixing member are fixedly installed on the frame, the first fixing member is opposite to the second fixing member, the first driving frame is hinged to the first fixing member, and the second driving frame is hinged to the second fixing member.

15. The hermetic tarpaulin device of claim 14, wherein a damping hinge is connected between the first fixing member and the first driving frame, between the first driving frame and the second driving frame, and between the second driving frame and the second fixing member.

16. The hermetic tarpaulin device of claim 12, wherein a magnetic attractor is provided between the first curtain and the second curtain, between the first curtain and other surfaces, and between the second curtain and other surfaces.

17. The hermetic tarpaulin device of claim 11, wherein the curtain comprises a first curtain and a second curtain, the first curtain and the second curtain move away from and approach each other to open or close the hermetical space, a first zipper is provided between a top of the first curtain and a surface adjacent to the top of the first curtain, a second zipper is provided between a top of the second curtain and a surface adjacent to the top of the second curtain, the driving mechanism comprises a first driving frame and a second driving frame hinged to the frame, the first driving frame is hinged to the second driving frame, a first curtain slider, a first slider driving assembly, a first zipper closure and a first zipper driving assembly are provided on the first driving frame, a second curtain slider, a second slider driving assembly, a second zipper closure and a second zipper driving assembly are provided on the second driving frame, the first slider driving assembly is configured to drive the first curtain slider to move along the first driving frame, the first zipper driving assembly is configured to drive the first zipper closure to move along the first driving frame, the first curtain slider is fixedly connected to the first curtain, the first zipper closure is fixedly connected to a zipper pull of the first zipper, the second slider driving assembly is configured to drive the second curtain slider to move along the second driving frame, the second zipper driving assembly is configured to drive the second zipper closure to move along the second driving frame, the second curtain slider is fixedly connected to the second curtain, and the second zipper closure is fixedly connected to a zipper head of the second zipper.

18. The hermetic tarpaulin device of claim 11, wherein the driving mechanism comprises an electric zipper provided between the curtain and other surfaces.

19. A nursing room, comprising:
a first support structure that is movable;
a second support structure that is movable, the second support structure and the first support structure being able to approach or move away from each other; and
the hermetic tarpaulin device of claim 1,
wherein a frame of the hermetic tarpaulin device is installed on the first support structure and the second support structure.

20. A nursing room, comprising:
a first support structure that is movable;
a second support structure that is movable;
a third support structure that is movable;
a fourth support structure that is movable, the fourth support structure, the third support structure, the second support structure and the first support structure being able to approach or move away from each other; and
the hermetic tarpaulin device of claim 1, wherein a frame of the hermetic tarpaulin device is installed on the first support structure, the second support structure, the third support structure and the fourth support structure.
